(19) United States
(12) Patent Application Publication
(10) Pub. No.: US 2015/0262489 A1
(43) Pub. Date: Sep. 17, 2015

(54) APPARATUS FOR PROVIDING IMAGES OF CURVED ROAD

(71) Applicant: MIR MATE CO.,LTD, Jeju-si Jeju-do (KR)

(72) Inventor: Moo Hong Sun, Jeju-si (KR)

(73) Assignee: MIR MATE CO., LTD, Jeju-si (KR)

(21) Appl. No.: 14/433,427

(22) PCT Filed: Oct. 2, 2013
(86) PCT No.: PCT/KR2013/008801

§ 371 Date: Apr. 3, 2015

(30) Foreign Application Priority Data
Oct. 5, 2012 (KR) 10-2012-0110965

(51) Int. Cl. G08G 1/00; H04N 7/18

(52) U.S. Cl. CPC G08G 1/207; H04N 7/183

(57) ABSTRACT

The present invention relates to an apparatus for providing images of a curved road and more particularly to an apparatus for providing images of a curved road, comprising: a first main body and a second main body, which are installed at a curved section of the curved road so as to face two different directions, wherein the first main body is equipped with a first camera and a first monitor, and the second main body is equipped with the first camera and the first monitor, thereby preventing safety accidents by enabling a driver entering from one direction of the curved road to clearly detect a vehicle, a bicycle, or a pedestrian entering from the other direction.

### TECHNICAL FIELD

The present invention generally relates to an apparatus for providing images of a curved road. More particularly, the present invention relates to an apparatus for preventing safety accidents by enabling a driver entering from one direction of a curved road to detect in advance a vehicle, a bicycle, or a pedestrian entering from the other direction.

### BACKGROUND ART

Generally, on a curved road, a mountain road, or a shoulder of a road, mirrors for securing a clear view are installed to help a pedestrian walking on the road or a driver driving on the road.

Most installed mirrors are convex mirrors because they can secure a wide angle of sight.

An existing road reflector may help to secure view when a pedestrian walks on a road or when a driver drives a vehicle, and may prevent safety accidents by being installed in blind spots attributable to each terrain shape.

However, existing road reflectors may distort images of objects thus causing inaccurate determination of the speed and distance of such objects. Furthermore, in rainy or foggy weather, it is difficult to detect objects reflected on the road reflector.

Additionally, objects cannot be detected when there is no light at night. Also, when a driver looks up at the reflector because it is installed at a high elevation, a risk factor may be caused due to the driver suddenly taking his or her eyes off the road.

### DISCLOSURE

### Technical Problem

Accordingly, the present invention has been made keeping in mind the above problems occurring in the related art, and an object of the present invention is to provide an apparatus for providing images of a curved road, in which two main bodies, respectively equipped with a camera, a warning light, a monitor, and a speaker, are disposed to face both directions of the curved road and the monitor each facing one direction outputs an image taken by the camera facing the other direction. Therefore, a driver entering from one direction of the curved road may accurately detect a vehicle, a bicycle, or a pedestrian entering from the other direction, so that safety accidents may be prevented in advance.

Also, another object of the present invention is to provide an apparatus for providing images of a curved road, in which an additional warning signal is provided when the driver fails to check the images, by adding a notification function using a sensor, a warning light, and a speaker. Therefore, safety accidents may be prevented.

### Technical Solution

In order to achieve the above objects, an apparatus for providing images of a curved road according to the present invention is installed at a curved section of the curved road, and includes a first main body and a second main body, which are disposed to face both directions of the curved road. The first main body is equipped with a first camera and a first monitor, and the second main body is equipped with a first camera and a first monitor.

A camera arranged in the first main body is displayed on the monitor of the second main body, and a camera arranged in the second main body is displayed on the monitor of the first main body.

Each of the first main body and the second main body further includes a warning light and a speaker, and the warning light and the speaker are operated by motion detection of a first sensor and a second sensor, and by control of a control unit, the first sensor and the second sensor being disposed to face the front road of the first main body and the second main body.

The first main body and the second main body are connected to a stanchion, wherein one side of the first main body is joined to an upper hinge, one side of the second main body is joined to a lower hinge, and a hinge post disposed in the upper part of the stanchion is joined with the upper hinge and the lower hinge, to enable the first main body and the second main body to rotate.

The first main body and the second main body may be separated and installed individually.

On a surface of the monitor, an anti-condensation coating film is applied.

### Advantageous Effects

As described above, in an apparatus for providing images of a curved road according to the present invention, two main bodies, respectively equipped with a camera, a warning light, a monitor, and a speaker, are disposed to face both directions of the curved road, and the monitor each facing one direction outputs an image taken by the camera facing the other direction. Accordingly, a driver entering from one direction may accurately detect a vehicle, a bicycle, and a pedestrian entering from the other direction, whereby safety accidents may be prevented in advance.

Also, by adding a notification function using a sensor, a warning light, and a speaker, an additional warning signal is provided in case a driver fails to check the image.

Therefore, safety accidents may be prevented.

### DESCRIPTION OF DRAWINGS

FIG. 1 is a perspective view illustrating an embodiment of an apparatus for providing images of a curved road according to the present invention;

FIG. 2 is a view illustrating another embodiment of an apparatus for providing images of a curved road according to the present invention;

FIG. 3 is a view illustrating a further embodiment of an apparatus for providing images of a curved road; and

FIG. 4 is a view illustrating that anti-condensation coating is applied to a monitor of an apparatus for providing images of a curved road.

### BEST MODE

The above and other objects, features and advantages of the present invention will be more clearly understood from the following detailed description when taken in conjunction with the accompanying drawings.

All terms or words used in the specification and claims should be interpreted as having a meaning that is consistent with their meaning in the context of the relevant art and will not be interpreted in an idealized or overly formal sense unless expressly so defined herein.

In an apparatus for providing images of a curved road 10 according to the present invention, two main bodies, which are respectively equipped with a camera, a warning light, a monitor, and a speaker, are disposed to face both directions of the curved road and the monitor each facing one direction outputs an image taken by the camera facing the other direction. Therefore, the apparatus for providing images of a curved road 10 may prevent safety accidents by enabling a driver entering from one direction to detect in advance a vehicle, a bicycle, and a pedestrian entering from the other direction.

In the specification, a curved road means that the road forms a curved line and the curve is so sharp that a driver of a vehicle entering from one direction cannot detect a road condition of the other direction, or means a road in which view of the other direction is hidden with obstructions such as road constructions, hills, and the like.

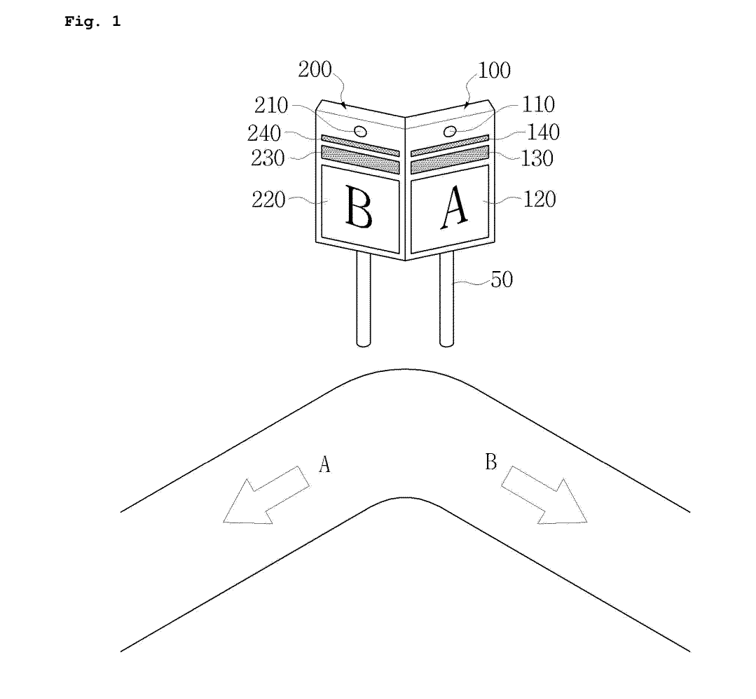

First, FIG. 1 is a perspective view illustrating an embodiment of an apparatus for providing images of a curved road 10. The apparatus for providing images of a curved road 10 according to the present embodiment is desirably installed in the location visible from vehicles that approach the curved road. In the present embodiment, an example in which the apparatus is installed in a lateral section of the curved road is provided.

The apparatus for providing images of a curved road 10 includes a first main body 100 and a second body 200, and each of the main bodies is equipped with a camera 110 or 220, a monitor 120 or 220, a warning light 130 or 230, and a speaker 140 or 240. The first main body 100 and the second main body 200 are disposed to face each direction of the curved road, and each of the main bodies 100 and 200 can be joined as one body or can be separated.

Also, a stanchion 50 is arranged in the lower part of each of the main bodies 100 and 200, and the height of the stanchion 50 may be set to enable a driver to detect the apparatus for providing images of a curved road 10.

The cameras 110 and 210 in the present invention are disposed frontward of the main bodies 110 and 120. It is desirable that the cameras 110 and 210 have adjustable photographing angles.

The monitors 120 and 220 in the present invention are devices for displaying images recorded by the cameras 110 and 210, and the size and resolution of the monitors 120 and 220 are set to enable a driver to detect the images in the distance of 10 to 50 m. The brightness of the monitors 120 and 220 can be automatically controlled to be bright during daytime, and to be dim at night.

The first main body 100 in the present embodiment is disposed toward the direction B. In the front part of the first main body 100, the first camera 110 is arranged to record images of vehicles that enter from the direction A. The recorded images are displayed on the second monitor 220 of the second main body 200 that will be described below.

Conversely, the second main body 200 is disposed toward the direction A. In the front part of the second main body 200, the second camera 210 is arranged to record images of vehicles that enter from the direction B. The recorded images are displayed on the first monitor 120 of the first main body 100.

Therefore, a driver of a vehicle entering from the direction A can detect an invisible road condition of the direction B. Similarly, a driver of a vehicle entering from the direction B can detect an invisible road condition of the direction A, whereby traffic accidents attributable to blocking of the view can be prevented.

Additionally, each of the main bodies 100 and 200 further includes a sensor 150 or 250, and a notification device operated by a control unit 300. Also, the front part of each of the main bodies 100 and 200 contains a warning light 130 or 230 and a speaker 140 or 240. Accordingly, though a driver fails to check the monitor 120 or 220, the driver may detect whether a vehicle, a bicycle, and a pedestrian enters from the other direction by the warning light 130 or 230 and by a warning sound of the speaker 140 or 240.

Specifically, the sensor is a motion-detecting sensor. The first sensor 150 is disposed toward the direction B and the second sensor 250 is disposed toward the direction A. When the sensor each senses a signal from any motion, the signal is delivered to the control unit 300. Then, the control unit 300 operates the warning light 130 or 230 and the speaker 140 or 240 of the main body 100 or 200 in the opposite direction.

For example, when a vehicle enters from the direction B, the first warning light 130 and the first speaker 140 of the first main body 100 are operated, whereas, when a vehicle enters from the direction A, the second warning light 230 and the second speaker 240 of the second main body 200 are operated.

On the other hand, the apparatus for providing image of a curved road stores the recorded images of the cameras 110 and 210 for a certain period of time, so that the images may be used for traffic accident records or crime evidence. Also, all of the apparatuses for providing images of a curved road 10 can be connected to a situation room 400 using wired or wireless communication. Accordingly, weather conditions or time information can be provided in real-time when a risk factor such as entry of a vehicle does not exist. Also, using remote control, the situation room 400 can provide or update advertisement videos through each of the monitor 120 and 220, or advertisement audio through the speaker. Furthermore, because the situation room 400 can detect whether the cameras 110 and 210 of the apparatus for providing images of a curved road 10 normally operate, malfunction of the cameras can be detected in real time and promptly repaired.

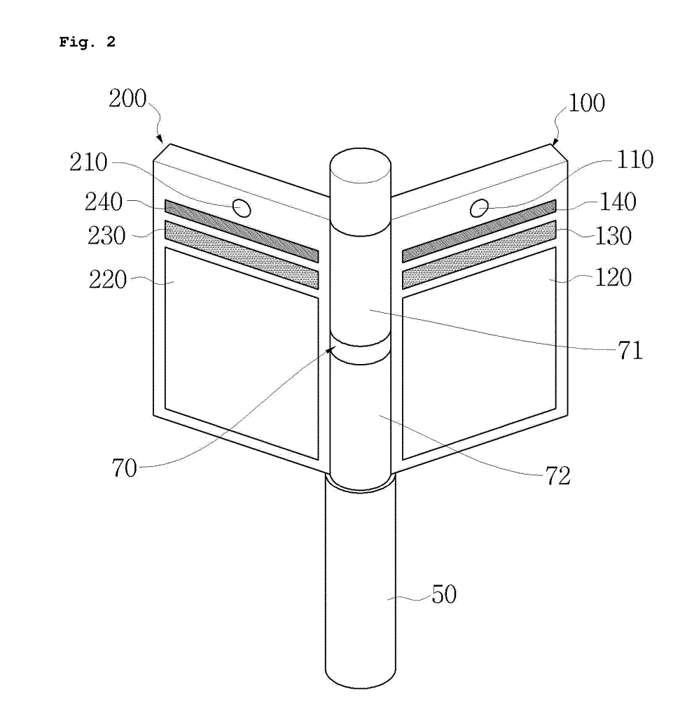

FIG. 2 illustrates another embodiment of the apparatus for providing images of a curved road 10 according to the present invention, wherein a hinge is arranged in the upper part of the stanchion 50 to connect the first main body 100 and the second main body 200 with the hinged connection.

Specifically, one side of the first main body 100 is joined to an upper hinge 71, and one side of the second main body 200 is joined to a lower hinge 72. The upper hinge 71 and the lower hinge 72 are joined to a hinge post 70 disposed in the upper part of the stanchion 50, and the first main body 100 and the second main body 200 may rotate on the stanchion 50. However, the present invention is not limited to the above description, and one side of the first main body 100 may be joined to the lower hinge 72 and one side of the second main body 200 may be joined to the upper hinge 71.

Because curved angles of the roads are not the same and the apparatus for providing images of a curved road 10 should be installed by considering the shapes or circumstances of the roads, the location of the apparatus may be different for each curved road.

Therefore, the directions that the first main body 100 and the second main body 200 face should be variably controlled, and the first main body 100 and the second main body 200 are configured to rotate on the stanchion 50 to adjust the angle thereof so as to cope with the shape of each curved road.

Also, in the case of the apparatus for providing images of a curved road 10, as the first main body 100 and the second main body 200 can be folded by the hinge connection, the volume of the apparatus may be reduced for storing. Additionally, as multiple pieces of the apparatus may be stacked, it has a space-saving effect and it is easy to convey the manufactured apparatus to the installation site.

Though not illustrated in the drawings, the first main body 100 and the second main body 200 may be configured for adjustment of the height thereof. For example, when one direction of the curved road has a slope, the main bodies are desirably configured to enable a driver to secure a viewing angle of the monitor from the direction that the driver enters.

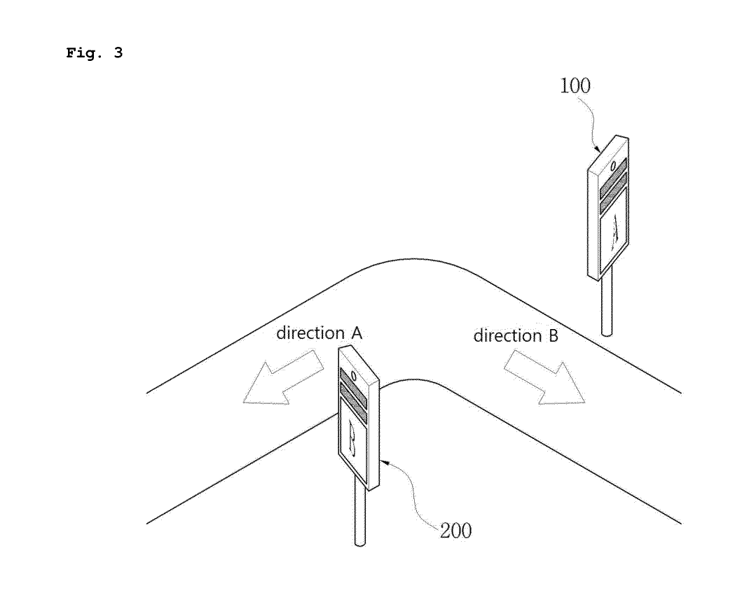

FIG. 3 illustrates a further embodiment of the apparatus for providing images of a curved road 10. In FIG. 3, the first main body 100 and the second main body 200, equipped with a camera, a monitor, a warning light, and a speaker, are separated and installed individually.

In this case, because the main bodies 100 and 200 are separated, a driver can more accurately and closely detect a road condition of the other direction before reaching the curved section. This configuration may be advantageous when the curved road has an inclined section.

Specifically, the first main body 100 in the present embodiment is disposed toward the direction B, the first camera 110 arranged in the front part of the first main body 100 records images of vehicles entering from the direction A, and the recorded images are displayed on the second monitor 220 of the second main body 200. The second main body 200 is disposed toward the direction A, the second camera 210 arranged in the front part of the second main body 200 records images of vehicles entering from the direction B, and the recorded images are displayed on the first monitor 220 of the first main body 100.

Therefore, a driver of a vehicle entering from the direction A can detect an invisible road condition of the direction B. Similarly, a driver of a vehicle entering from the direction B can detect an invisible road condition of the direction A, whereby traffic accidents attributable to blocking of the view may be prevented.

Also, like the embodiment described above, each of the main bodies 100 and 200 further includes a sensor 150 or 250, and a notification device operated by a control unit 300. A warning light 130 or 230 and a speaker 140 or 240, arranged in the front part of each of the main bodies 100 and 200, make a light and alarm to clearly signal whether a vehicle, a bicycle, and a pedestrian has entered from the other direction.

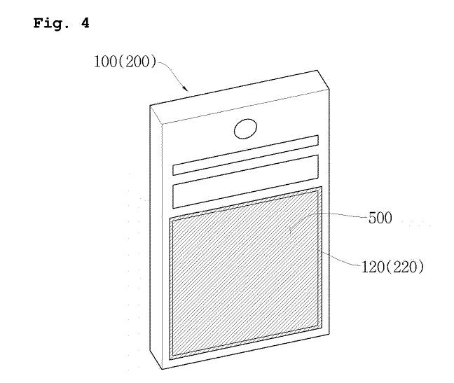

On the other hand, FIG. 4 illustrates that a coating film 500 is applied to a monitor of the apparatus for providing images of a curved road 10. The coating film 500 is an anti-condensation coating film 500 that prevents the development of condensation on the surface of the monitor when the temperature has fallen below the dew point. The coating film 500 prevents various kinds of information provided to drivers from being hidden due to the condensation on the monitor 120 or 220 caused by rainy weather or the like.

The coating film 500 is formed by applying a hydrophilic surfactant, wherein the surface of the monitor becomes hydrophilic and condensation is prevented by the action of the hydrophilic surfactant. More specifically, the hydrophilic surfactant is applied after mixing a polymerization surfactant monomer and an initiator, and polymerization of the polymerization surfactant monomers forms the coating film 500.

Here, the hydrophilic surfactant contains at least one hydrophilic group selected from a group consisting of a hydroxyl group, an amino group, an ammonium group, and an SO₃ group, and contains at least one lipophilic group selected from a group consisting of an acyclic hydrocarbon radical, an aromatic hydrocarbon radical, and an alkyl group. The coating film 500 arranges the lipophilic group on the surface of the monitor to increase mutual adhesion, and arranges the hydrophilic group on the surface exposed outside to provide hydrophile property, whereby the condensation may be prevented.

Also, the hydrophilic surfactant has an HLB value from 25 to 35. The HLB value shows a feature of the surfactant and it has the value according to hydrophile-lipophile balance of the molecules of the surfactant. The HLB value indicates polarity of the molecules in the range of 0.1 to 40. A high HLB value indicates that hydrophile property increases, whereas a low HLB value indicates that lipophile property increases. When a hydrophobic surfactant has an HLB value less than 25, the surfactant has very little hydrophilic group, and thus prevention of the condensation is less effective. Also, the hydrophobic foreign material is settled on the surface of the monitor, thus obstructing the view. Conversely, when an HLB value is greater than 35, there may be a problem in adhesion of the coating film and the monitor due to an excessive level of hydrophilic group. Therefore, the range of the HLB value is limited as the above description.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

Mode for Invention

| 10: apparatus for providing images of curved road | |
|---|---|
| 100: first main body | |
| 110: first camera | 120: first monitor |
| 130: first warning light | 140: first speaker |
| 200: second main body | 210: second camera |
| 220: second monitor | 230: second warning light |
| 240: second speaker | 300: control unit |
| 400: situation room | 500: coating film |

1. An apparatus for providing images of a curved road, comprising:
a first main body equipped with a first camera, a first monitor, a warning light, a speaker, and a first sensor;
a second main body equipped with a second camera, a second monitor, a warning light, a speaker, and a second sensor,
the first main body and the second main body being disposed at opposite locations to face both directions in a curved section of the curved road; and
a control unit, for controlling the warning light and speaker of the second main body to be operated by sensing of the first sensor, and for controlling the warning light and speaker of the first main body to be operated by sensing of the second sensor,
wherein, when the first sensor detects a vehicle, an image recorded by the first camera is displayed on the second monitor, and when the second sensor detects a vehicle, an image recorded by the second camera is displayed on the first monitor,
wherein, when the first sensor or the second sensor does not detect a vehicle, the first monitor or the second monitor, which is respectively opposite to the first sensor or the second sensor, displays one or more among real-time weather information, time information, and an advertisement video, and the speaker provides an advertisement audio corresponding to the advertisement video, and
wherein a situation room is configured to remotely update and control the real-time weather information, the time information, the advertisement video, and the advertisement audio, provided by the first monitor, the second monitor, and the speaker.

2. The apparatus of claim 1, wherein:
on a surface of the monitor, a coating film formed by a hydrophilic surfactant is configured, and the hydrophilic surfactant contains at least one hydrophilic group selected from a group consisting of a hydroxyl group, an amino group, an ammonium group, and an SO₃ group, and contains at least one lipophilic group selected from a group consisting of an acyclic hydrocarbon radical, an aromatic hydrocarbon radical, and an alkyl group, and
the hydrophilic surfactant has an HLB value from 25 to 35.
